(19) United States
(12) Patent Application Publication
(10) Pub. No.: US 2019/0255852 A1
(43) Pub. Date: Aug. 22, 2019

(54) MANUFACTURING METHOD OF LIQUID EJECTION HEAD

(71) Applicant: CANON KABUSHIKI KAISHA, Tokyo (JP)

(72) Inventors: Tomohiko Nakano, Fukushima-shi (JP); Keiji Watanabe, Kawasaki-shi (JP); Koji Sasaki, Nagareyama-shi (JP)

(21) Appl. No.: 16/267,660

(22) Filed: Feb. 5, 2019

(30) Foreign Application Priority Data
Feb. 22, 2018 (JP) 2018-029886

(51) Int. Cl. B41J 2/16; B41J 2/14

(52) U.S. Cl. CPC B41J 2/1631; B41J 2/1626; B41J 2/1645; B41J 2/14145

(57) ABSTRACT

Provided is a manufacturing method of a liquid ejection head including the following in an order listed: (1) providing a negative, photosensitive first resin layer on a first surface of a substrate, (2) forming a latent image of a pattern of a liquid flow path by exposure on the first resin layer, (3) providing a negative, photosensitive second resin layer on the first resin layer, (4) forming a latent image of a pattern of the liquid ejection orifice by exposure on the second resin layer, (5) heating the first and second resin layers at a certain temperature to obtain a certain Vickers hardness of a non-latent image portion of the second resin layer, and (6) heating the first and second resin layers at a temperature more than or equal to the softening temperature of the first resin layer.

### BACKGROUND OF THE INVENTION

### Field of the Invention

The present invention relates to a manufacturing method of a liquid ejection head.

### Description of the Related Art

A liquid ejection head is used in a liquid ejection device such as an inkjet recording device, and has a flow path forming member and a substrate. The flow path forming member is provided on a substrate, and forms a flow path or ejection orifice of liquid. On the substrate, a liquid supply port is formed, and the liquid supplied from the liquid supply port to the flow path is ejected from the ejection orifice, and landed on a recording medium such as paper.

Japanese Patent Application Laid-Open No. 2015-104876 discloses a manufacturing method of a liquid ejection head in which first and second negative photosensitive resins are used to form a flow path forming member on a substrate. In this method, a first photosensitive resin layer is formed on a substrate and exposed to light to make a latent image of the pattern of the liquid flow path on the first photosensitive resin layer. Subsequently, a second photosensitive resin layer is laminated thereto and exposed to light, thereby making a latent image of the pattern of the ejection orifice on the second photosensitive resin layer. Then, these photosensitive resin layers are heated and developed together, thereby obtaining a flow path forming member. This heating is called bake after exposure, or post exposure bake (PEB), and the latent image pattern after exposure can be stabilized by this heating.

### SUMMARY OF THE INVENTION

According to an aspect of the present invention, there is provided
a manufacturing method of a liquid ejection head including a substrate and a flow path forming member, the substrate being provided with a liquid ejection energy generating element on a first surface, the flow path forming member having a liquid ejection orifice and forming a liquid flow path between the flow path forming member and the first surface, the method including the following in an order listed:
(1) providing a negative first photosensitive resin layer on the first surface,
(2) forming a latent image of a pattern of the liquid flow path by exposure on the first photosensitive resin layer,
(3) providing a negative second photosensitive resin layer on the first photosensitive resin layer,
(4) forming a latent image of a pattern of the liquid ejection orifice by exposure on the second photosensitive resin layer,
(5) heating the first and second photosensitive resin layers at a temperature less than a softening temperature of the first photosensitive resin layer, so that a Vickers hardness of a non-latent image portion of the second photosensitive resin layer is 80% or more of a Vickers hardness of the non-latent image portion after (6), and
(6) heating the first and second photosensitive resin layers at a temperature more than or equal to the softening temperature of the first photosensitive resin layer.

Further features of the present invention will become apparent from the following description of exemplary embodiments with reference to the attached drawings.

### BRIEF DESCRIPTION OF THE DRAWINGS

FIG. 1 is a schematic perspective view illustrating an example of a liquid ejection head.

FIGS. 2A, 2B, 2C, 2D, 2E, 2F, and 2G are schematic cross-sectional views for describing a manufacturing method of a liquid ejection head according to an embodiment of the present invention.

FIG. 3 is a conceptual diagram illustrating an example of a heating method in PEB.

FIGS. 4A, 4B, 4C, 4D, 4E, 4F, 4G and 4H are schematic cross-sectional views for describing a manufacturing method of a liquid ejection head according to another embodiment of the present invention.

FIG. 5 is a schematic cross-sectional view illustrating a liquid ejection head obtained in a Comparative Example.

### DESCRIPTION OF THE EMBODIMENTS

According to the present inventors' review, it was found that in the method described in Japanese Patent Application Laid-Open No. 2015-104876, an unexposed portion of a first photosensitive resin layer was softened and flows due to heating at the time of PEB, and a second photosensitive resin layer may be deformed into a form of the flow. As a result, flatness of the surface of the flow path forming member (a surface opposite to the substrate) may be reduced.

Accordingly, the object of the present invention is to provide a manufacturing method of a liquid ejection head which may suppress the reduction in flatness of the flow path forming member, and contributes to manufacturing a liquid ejection head having a good shape.

Embodiments for carrying out the present invention will now be described in detail in accordance with the accompanying drawings, but the present invention is not limited thereto.

<Liquid Ejection Head>

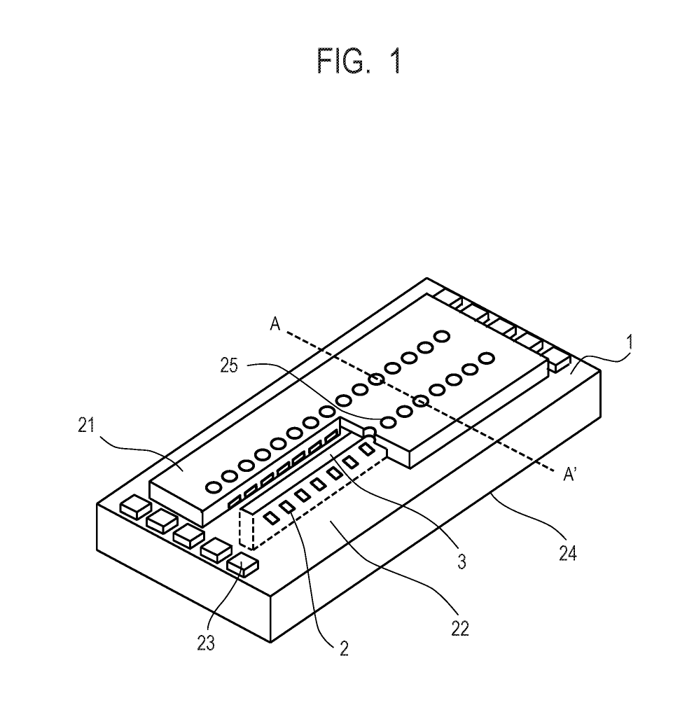

An example of a liquid ejection head which can be manufactured by the present invention is shown in FIG. 1. The liquid ejection head has a substrate 1 and a flow path forming member 21. The substrate 1 is for example, formed of silicon. Hereinafter, a surface of the substrate 1 (upper surface in FIG. 1) may be referred to as a first surface 22. A liquid ejection energy generating element 2 is formed on the first surface 22 of the substrate 1. An example of the liquid ejection energy generating element 2 may include a heating resistor or a piezoelectric element. The liquid ejection energy generating element 2 may be formed so as to be in contact with the first surface 22, or formed in a state in which a portion of the element floats to the first surface 22. In addition, a bump 23 is formed on the first surface 22, and the liquid ejection energy generating element 2 is driven by electric power supplied from the outside of the substrate through the bump 23. On the substrate 1, a liquid supply port 3 is formed, which penetrates the substrate from the first surface 22 to a second surface 24 which is the rear surface of the first surface. The liquid supply port 3 may be formed in any step before forming, during forming, or after forming the flow path forming member 21. The flow path forming member 21 forms a liquid flow path between the flow path forming member 21 and the first surface 22. To liquid supplied from the liquid supply port 3, energy is imparted by the driven liquid ejection energy generating element 2, and ejected from a liquid ejection orifice 25 formed on the flow path forming member 21.

The first surface 22 and the second surface 24 of the substrate 1 may be flat or may have unevenness. For example, the first surface 22 may have unevenness by providing wiring on the surface or locally disposing a functional layer. Here, the larger the unevenness, the easier the flatness is reduced when forming the flow path forming member in the process. The present invention is particularly effective in this case, and for example, when the first surface has unevenness of more than 1 the effect of the present invention is more significantly obtained.

The substrate 1 may have a hole opening to the first surface 22. The hole may be a through-hole such as the liquid supply port 3. Otherwise, the hole may be a bottomed hole which opens to the first surface 22 but does not open to the second surface 24

<Manufacturing Method of Liquid Ejection Head>

A manufacturing method of the liquid ejection head has the following steps in the order listed:
(1) providing a negative first photosensitive resin layer (hereinafter, also referred to as a “first resin layer”) on the first surface of the substrate,
(2) forming a latent image of a pattern of the liquid flow path by exposure on the first resin layer,
(3) providing a negative second photosensitive resin layer (hereinafter, also referred to as a “second resin layer”) on the first resin layer,
(4) forming a latent image of a pattern of the liquid ejection orifice by exposure on the second resin layer,
(5) heating the first resin layer and the second resin layer at a temperature less than a softening temperature of the first resin layer (hereinafter, also referred to as a “first softening temperature”), so that a Vickers hardness of a non-latent image portion of the second resin layer is 80% or more of a Vickers hardness of the non-latent image portion after step (6) (additionally, hereinafter, the softening temperature of the second resin layer is also referred to as “a second softening temperature”), and
(6) heating the first resin layer and the second resin layer at a temperature more than or equal to the first softening temperature.

In addition, the flow path forming member may include a flow path wall constituting a side wall of the liquid flow path and an ejection orifice forming member with the liquid ejection orifice formed. The ejection orifice forming member traditionally has a plate shape with the liquid ejection orifice formed. The first resin layer is used to form the flow path wall, and the second resin layer is used to form the ejection orifice forming member.

In addition, both of the first and second softening temperatures refer to a softening temperature of the resin layer before exposure.

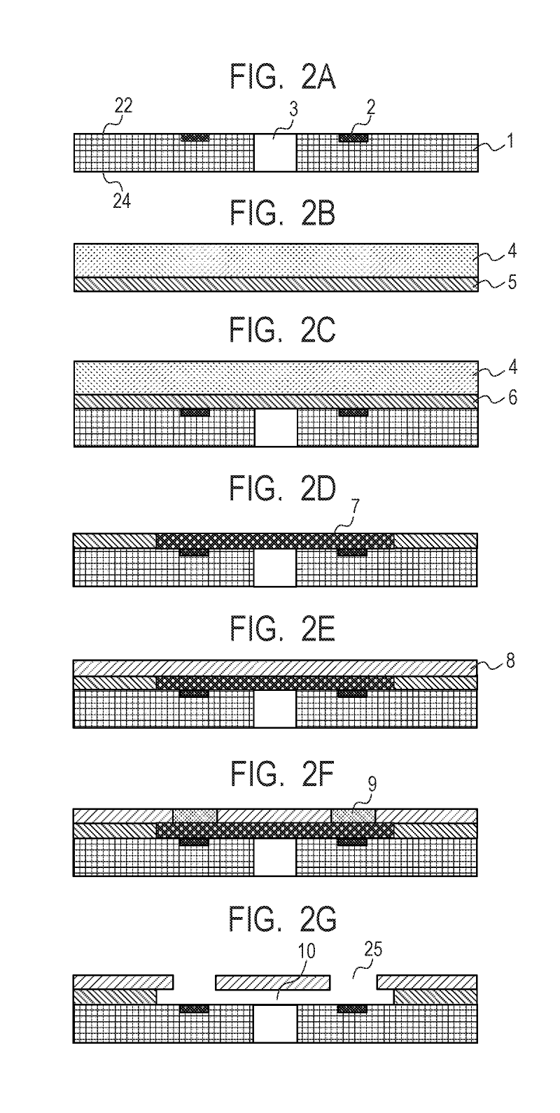

Hereinafter, a manufacturing method of a liquid ejection head according to an embodiment of the present invention. FIGS. 2A to 2G is a schematic cross-sectional view corresponding to an A-A′ section of the liquid ejection head shown in FIG. 1. FIGS. 2A to 2G illustrate that the liquid supply port 3 (through-hole) is formed before the flow path forming member 21 is formed, and the first resin layer 6 is formed by transfer of a dry film 5.

Substrate

First, as shown in FIG. 2A, the substrate 1 having the liquid ejection energy generating element 2 on the first surface 22 is prepared. The liquid ejection energy generating element 2 is covered by a protection film (not shown) formed by SiN or SiO₂.

The liquid supply port 3 is formed on the substrate 1. The liquid supply port 3 is a through-hole opening to the first surface 22 and the second surface 24 of the substrate 1. Examples of a method of forming the liquid supply port 3 may include laser processing, reactive ion etching, sand blast, and wet etching. The method may be also used, when the liquid supply port 3 is formed during or after formation of the flow path forming member 21.

Dry Film (for First Resin Layer)

Next, as shown in FIG. 2B, a dry film 5 supported by a support 4 is prepared. Examples of the support 4 may include a resin film, glass, and silicon. The support 4 is preferably a resin film which can be easily removed by peeling, considering that the substrate is removed later. Examples of a material of the resin film may include polyethylene terephthalate (PET), or polyimide, polyamide, polyaramid, polytetrafluoroethylene, polyvinyl alcohol, polycarbonate, polymethyl pentene, and a cycloolefin polymer.

The dry film 5 is formed using a negative photosensitive resin. Examples of the resin may include an epoxy resin, an acrylic resin, and a urethane resin. An example of the epoxy resin may include a bisphenol A or a cresol novolac resin, or a cycloaliphatic epoxy resin, an example of the acrylic resin may include polymethylmethacrylate, and an example of the urethane resin may include polyurethane. Examples of a solvent which dissolves these resins may include propylene glycol methyl ether acetate (PGMEA), cyclohexanone, methyl ethyl ketone, and xylene. A photoacid generator can be appropriately added to the photosensitive resin.

The dry film can be obtained by drying a solution of the photosensitive resin, for example, drying a resin solution produced by synthesizing the photosensitive resins. The obtained dry film has different softening temperatures depending on the type of photosensitive resin or a ratio of the solvent remaining after drying.

The softening temperature can be obtained by the following method. A substrate having a square opening portion of 10 mm×10 mm (a square 10 mm on a side) is prepared, and the opening portion is closed using a filler (so that the substrate of the non-opening portion and the filler of the opening portion form a flat surface). As the substrate, a material having high thermal conductivity such as stainless steel (SUS) or Si is used. A dry film is formed on the substrate so that the opening portion is covered, and then the filler is removed. Here, the thickness of the dry film is 5 μm to 30 μm. In this state, the substrate and the dry film are heated at a constant temperature for 60 seconds, and a step difference between a dry film surface on the opening portion and a dry film surface on the non-opening portion is measured. For measuring the step difference, a contact type step meter, a non-contact type optical measuring device, or the like can be used. The step difference mentioned herein refers to “a height difference between a dry film surface of the most depressed portion of the dry film in the opening portion and a dry film surface of non-depressed portion of the dry film in the non-opening portion”. A measuring temperature is changed to perform the same measurement, and a lowest temperature at which the step difference is more than 1% of the thickness of the dry film at the time of formation, is determined as the softening temperature. In addition, this method can be used for obtaining the softening temperature of the dry film for the second resin layer, without limitation to the first resin layer. In addition, this method can be used for obtaining the softening temperature of the photosensitive resin layer formed by a coating method such as spin coating or slit coating, without limitation to the softening temperature of the dry film.

The photosensitive resin may be a positive type or a negative type, and since a non-latent image portion finally remains as the flow path forming member, a negative photosensitive resin which easily increases adhesiveness with the substrate or a hardness of the member itself is used.

The dry film 5 can be formed on the support by appropriately dissolving the photosensitive resin in a solvent, coating the solution on the support by spin coating, slit coating, or the like, and drying the solution. A film thickness of the dry film 5 is not particularly limited, however, for example, the film thickness can be determined so that the first resin layer has a thickness of 3 μm or more and 50 μm or less.

It is preferred that the softening temperature of the photosensitive resin forming the dry film 5, and thus, the first softening temperature is 50° C. or more. Thus, it is easy to suppress a decrease in flatness due to softening or flowing the first resin layer 6, when performing PEB.

Formation of First Resin Layer

Next, as shown in FIG. 2C, the dry film 5 supported by the support 4 is transferred to the first surface 22 of the substrate 1, thereby forming the first resin layer 6 for forming a portion of the flow path forming member 21 (e.g., the flow path wall) on the substrate 1. It is preferred that the first resin layer 6 is formed with good flatness on the first surface 22 of the substrate 1. For example, the conditions at the time of transfer (e.g., temperature and pressure) can be set so that unevenness of the surface of the first resin layer 6 is 5 μm or less.

The unevenness on the surface of the first resin layer 6 is obtained by measuring a step difference over the entire area in which the first resin layer is formed, using the contact type step meter or the non-contact type optical measuring device (the maximum value is adopted as the value of unevenness among the measured step differences). In the case that a specific portion has significant unevenness, such as that wiring, a functional layer, or the like is provided on the substrate surface, only a corresponding portion can be representatively measured for convenience of measurement.

Regarding the temperature at the time of transfer, the resin is softened by performing transfer at a temperature higher than the first softening temperature, whereby the surface of the first surface 22 of the substrate 1 can be coated with the first resin layer 6 well (with good flatness).

In addition, formation of the first resin layer 6 on the first surface 22 can be performed by a coating method such as spin coating or slit coating, instead of dry film transfer. When using these methods also, it is preferred that the first softening temperature is 50° C. or more, like the above. In addition, it is preferred that the first resin layer 6 is formed on the surface of the first surface 22 of the substrate 1 with good flatness. For formation with good flatness, the viscosity of a resin solution obtained by adding a solvent to a photosensitive resin can be increased. With high viscosity, it is difficult for the coated resin solution to follow the unevenness of the substrate surface, and as a result, the flatness of the coated film can be improved.

When the first resin layer 6 is formed on the first surface 22 by spin coating or slit coating, the liquid supply port 3 can be also formed in any step before, during, and after forming the first resin layer 6. However, when the liquid supply port 3 is formed before forming the first resin layer 6, it is preferred to perform a method such as a method of sealing the opening of the liquid supply port or filling the inside of the liquid supply port, for preventing the resin from entering into the liquid supply port 3.

Exposure of First Resin Layer

Next, as shown in FIG. 2D, a latent image of the pattern 7 of the liquid flow path is formed on the first resin layer 6 by exposure. The flow path wall of the flow path forming member 21 can be formed by the non-latent image portion of the first resin layer 6. Since the first resin layer 6 is the negative photosensitive resin layer, the pattern 7 is an unexposed portion.

Formation of Second Resin Layer

Next, as shown in FIG. 2E, in order to form a portion of the flow path forming member 21 (e.g., ejection orifice forming member), the second resin layer 8 is formed on the first resin layer 6. An example of a method of forming the second resin layer 8 may include spin coating, slit coating, or dry film transfer. Among these methods, from the viewpoint of surface flatness of the second resin layer 8, it is preferred to use dry film transfer which allows edge bead removal. As the photosensitive resin used in the second resin layer, the negative photosensitive resin is used for the same reason as the first resin layer.

In the case of dry film transfer, for coating the surface of the first resin layer 6 which is a lower layer well, it is preferred that the temperature at the time of transfer is set to a temperature higher than the second softening temperature. Thus, transfer can be performed while the second resin layer 8 is softened. In addition, from the viewpoint of prevention of softening and flowing of the first resin layer 6, it is preferred that the temperature at the time of this transfer is lower than the first softening temperature. That is, it is preferred that the temperature at the time of transfer is set to be higher than the second softening temperature and lower than the first softening temperature. By doing this, the second resin layer 8 can be easily coated well on the first resin layer 6, while the flatness of the first resin layer 6 is maintained. In addition, in this case, the second softening temperature is lower than the first softening temperature.

From the viewpoint of ejection performance, it is preferred that the second resin layer 8 is formed with good flatness, and for example, the conditions at the time of transfer (e.g., temperature and pressure) can be set, so that the unevenness of the surface of the transferred second resin layer 8 is 5 μm or less. The unevenness of the surface of the second resin layer 8 can be measured identically to the case of the first resin layer.

The film thickness of the second resin layer 8 is not particularly limited, however, for example, can be 3 μm or more and 50 μm or less.

In addition, particularly as described above, when the second resin layer 8 is formed by dry film transfer, it is preferred that a difference between the first softening temperature and the second softening temperature is 10° C. or more, from the viewpoint of temperature control. In addition, it is preferred that the second softening temperature is lower than the first softening temperature. Therefore, it is preferred that the second softening temperature is lower than the first softening temperature by 10° C. or more. For example, the first resin layer having the first softening temperature of 50° C. or more and the second resin layer having the second softening temperature of 40° C. or less can be used.

Exposure of Second Resin Layer

Next, as shown in FIG. 2F, a latent image of the pattern 9 of the liquid ejection orifice is formed on the second resin layer 8 by exposure. The ejection orifice forming member of the flow path forming member 21 can be formed by a non-latent image portion of the second resin layer 8. When the second resin layer 8 is the negative photosensitive resin layer, the pattern 9 is the unexposed portion.

Bake after Exposure

Next, heating of the first resin layer 6 and the second resin layer 8, that is, PEB is performed. PEB is effective for accelerating an acid generation reaction occurring when exposing the photosensitive resin, thereby forming a fine pattern well. The pattern of the exposed portion of the first resin layer 6 and the second resin layer 8 for constituting the flow path forming member 21 is stabilized by PEB.

When the negative photosensitive resin is used in the first and second resin layers, PEB is performed after exposure to cause an acid-catalyzed crosslinking reaction, thereby obtaining a negative pattern which is not dissolved at the time of development. This negative pattern is stabilized and the hardness thereof is increased, as the crosslinking reaction by PEB proceeds. The temperature and the time required for a final attained hardness by completing the crosslinking reaction by PEB are different from the photosensitive resin, however, when the required temperature is higher than the softening temperature of the photosensitive resin, the photosensitive resin of the unexposed portion is softened, whereby the shape is deformed. The flow path forming member 21 is composed of a portion derived from the first resin layer 6 and a portion derived from the second resin layer 8. These layers have different exposed areas from each other for forming the liquid flow path. The first resin layer 6 is in direct contact with the first surface 22 of the substrate 1. Thus, the temperature used at the time of PEB may be higher than the first softening temperature, or the unexposed portion of the first resin 6 may be softened to flow, in particular, into an unevenness portion or a through-hole. The second resin layer 8 laminated on the unexposed portion of the first resin 6 has an exposed portion and an unexposed portion, and the exposed portion is cured by a crosslinking reaction during PEB. However, when the unexposed portion of the first resin layer 6 flows at the stage in which the curing does not sufficiently proceed, second resin layer 8 may be deformed to follow it.

Even in the case that the second resin layer 8 is softened, when the first resin layer 6 disposed beneath the second resin layer is not softened and does not flow, the second resin layer 8 is not deformed. In addition, even in the case that the first resin layer 6 is softened and flows, when the hardness of the second resin layer 8 itself is sufficiently high, the second resin layer 8 is not deformed. Thus, after the second resin layer 8 has sufficient hardness by heating at a temperature less than the first softening temperature, heating may be performed until the second resin layer 8 reaches a final attained hardness without deforming the second resin layer 8. Accordingly, it is effective that PEB is performed in a temperature range of less than the first softening temperature to proceed with curing of the second resin layer 8 (step (5)), and then PEB is performed in a temperature range of the first softening temperature or more (step (6)). Hereinafter, when PEB is performed, the temperature range of less than the first softening temperature is referred to as “STEP1 temperature range”, and the temperature range of the first softening temperature or more may be referred to as “STEP2 temperature range”. In addition, in step (5), the second resin layer 8 may be softened or not be softened.

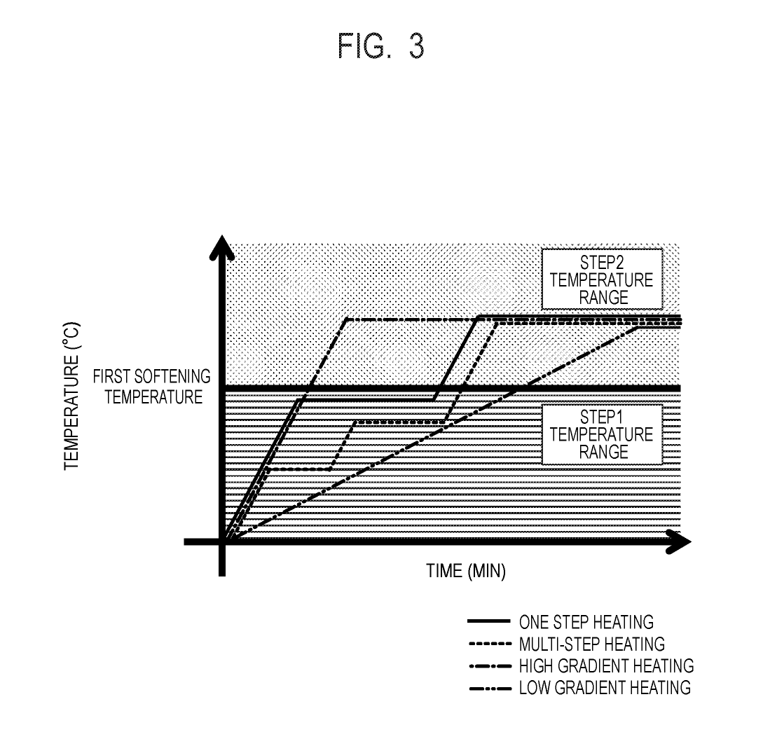

An example of a heating method of PEB is conceptually shown in FIG. 3. In FIG. 3, the horizontal axis is PEB time, and the vertical axis is PEB temperature. In an example of “high gradient heating” shown in FIG. 3, heating to a temperature higher than the first softening temperature (final temperature) with a high temperature gradient (at a constant heating rate) is performed, and then the temperature is maintained at the temperature. In this case, since the heating time in the STEP1 temperature range is short, the second resin layer 8 undergoes heating in the STEP2 temperature range with insufficient curing progress. Accordingly, there is a concern that the second resin layer 8 is deformed. However, in an example of the “low gradient heating”, heating to the temperature is slow, so that the second resin layer 8 undergoes heating in the STEP1 temperature range for a long time. Thus, the second resin layer 8 undergoes heating in the STEP2 temperature range after the hardness is sufficiently increased. Accordingly, deformation of the second resin layer 8 is easily suppressed.

Preferably, as shown in an example of “one step heating” in FIG. 3, heating is performed with a high temperature gradient, and then heating is stopped in a high temperature range in a STEP1 temperature range and the temperature is maintained constant (heating at a low temperature gradient may be performed instead of stopping heating). Subsequently, heating is performed again with a high temperature gradient, and after a final temperature is reached, the temperature is maintained constant. In this example, since heating can be performed early at a high temperature range in the STEP1 temperature range, as compared with an example of low gradient heating, time for PEB can be reduced. It is preferred that the high temperature range in the STEP1 temperature range referred to herein is within a range of −10° C. from the first softening temperature. In addition, as shown in an example of “multistep heating” in FIG. 3, if necessary, heating with a high temperature gradient, then at a constant temperature (or with low temperature gradient), and again with a high temperature gradient, within the STEP1 temperature range, can be carried out multiple times.

In PEB (step (5)) in the STEP1 temperature range, heating is performed so that the hardness of the non-latent image portion of the second resin layer 8 is 80% or more of the final attained hardness (hardness of the non-latent image after step (6)). By doing this, even in the case that the first resin layer 6 is softened at the time of heating in the STEP2 temperature range (step (6)), deformation of the second resin layer 8 can be suppressed well. The ratio of the hardness after step (5) to the final attained hardness of the second resin layer 8 can be less than 100%, and furthermore, 90% or less.

In addition, as the hardness, Vickers hardness which is measured using an indenter or the like is used. As shown in JISZ2244, a square pyramidal diamond indenter is pushed to the surface of the measured object (the non-latent image portion of the second resin layer), the test force F is released, then a diagonal length of a recess portion remaining on the surface is measured, and hardness is obtained. A test temperature is 23° C.±5° C. When the hardness has a possibility of being influenced by the hardness of the first resin layer, the measured portion is the non-latent image portion of the first resin layer and the non-latent image portion of the second resin layer.

After PEB in the STEP1 temperature range is performed, in order to cure the first resin layer 6 and the second resin layer 8 to the final attained hardness, PEB in the STEP2 temperature range is performed (step (6)). Here, curing of the exposed portion of the second resin layer 8 in the previous step, that is, step (5) has already proceeded. Thus, in step (6), though the unexposed portion of the first resin layer 6 is softened and flows, heating at the temperature and time required for curing to the final attained hardness can be performed while deformation of the second resin layer 8 is suppressed. In PEB in the STEP2 temperature range also, conversion of temperature gradient can be performed a multiple times.

An example of an example of a heating method used in PEB may include a method of bring the second surface 24 of the substrate into contact with a hot plate, or a method of placing the substrate with the first resin layer and the second resin layer formed thereon in an oven. Other than that, there is a method of heating a substrate on which the first resin layer and the second resin layer are formed, particularly using a non-contact type heating source such as a halogen lamp, from the side of the second resin layer. From the viewpoint of maintaining the flatness of the flow path forming member 21, a method of heating the substrate from the side of the second resin layer is preferred. By heating the substrate from the side of the second resin layer, the second resin layer 8 which is a layer on the outermost surface is heated before the first resin layer 6 which is the lower layer. Thus, curing of the exposed portion of the second resin layer 8 is performed before softening and flowing of the unexposed portion of the first resin layer 6, whereby flatness of the flow path forming member 21 is maintained better.

Development

Next, as shown in FIG. 2Q the pattern 7 of the liquid flow path and the pattern 9 of the liquid ejection orifice are developed. Thus, the flow path forming member 21 having the liquid flow path 10 and the liquid ejection orifice 25 is formed, whereby the liquid ejection head can be obtained. Here, if necessary, the substrate is cut and separated by a dicing saw or the like into chips of individual liquid ejection heads. In addition, electrical wiring for appropriately driving the liquid ejection energy generating element is performed, whereby a chip tank member for supplying liquid is bounded.

In the manufacturing method of the liquid ejection head, reduced flatness of the flow path forming member is prevented, while the highest temperature at the time of PEB can be the first softening temperature or more and the second softening temperature or more.

### Examples

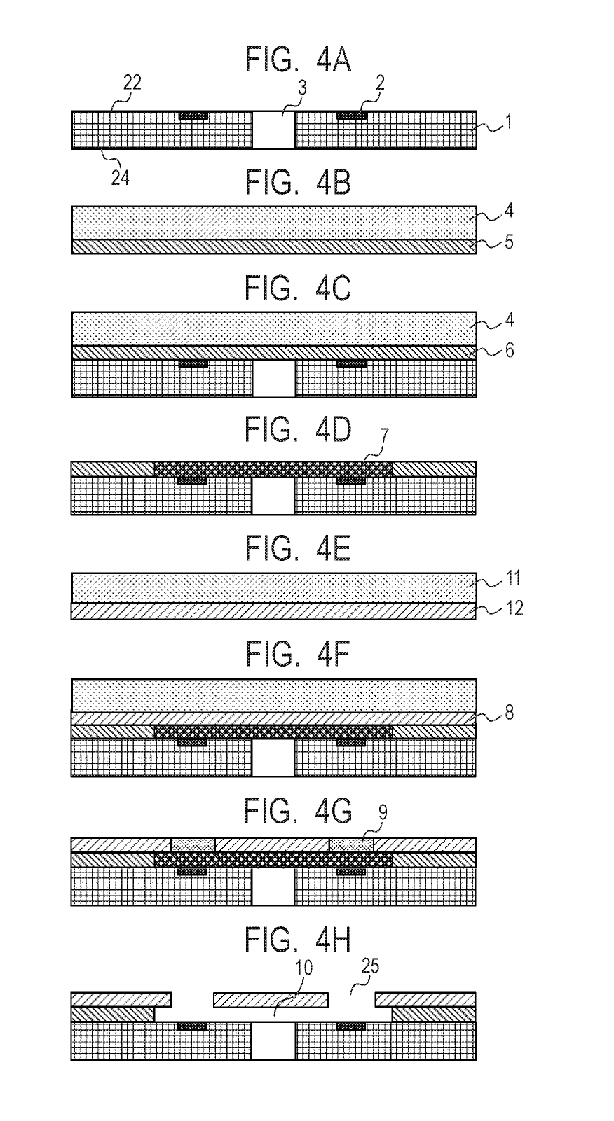

Hereinafter, the present invention will be described in more detail, referring to FIGS. 2A to 2G and FIGS. 4A to 4H. FIGS. 4A to 4H are the schematic cross-sectional views corresponding to the A-A′ cross section of the liquid ejection head of FIG. 1.

### Example 1

First, as shown in FIG. 2A, the substrate 1 having the liquid ejection energy generating element 2 composed of TaSiN on the side of the first surface 22 was prepared. As the substrate 1, a (100) substrate of silicon was used. The substrate 1 had a protection film (not shown) formed of SiN. On the substrate 1, the liquid supply port 3 was formed. The liquid supply port 3 was a through-hole opening to the first surface 22 and the second surface 24 of the substrate 1. The liquid supply port 3 was formed by a Bosch process in a reaction ion etching (ME) manner.

Next, as shown in FIG. 2B, the dry film 5 supported by the support 4 was prepared. As the support 4, a PET film having a thickness of 100 μm was used, and the dry film-formed surface was subjected to release treatment. As a coating solution for forming the dry film 5, a solution obtained by dissolving an epoxy resin (manufactured by DIC Corporation, product name: EPICLON N-695) and a photoacid generator (manufactured by San-Apro Ltd., product name: CPI-210S) in PGMEA was prepared. The coating solution was coated on the dry film-formed surface of the support 4, and dried at 90° C. by the oven to form the dry film 5. The dry film 5 had a softening temperature (thus, the softening temperature of the first resin layer 6) of 55° C.

Next, as shown in FIG. 2C, the dry film 5 supported by the support 4 was adhered on the first surface 22 of the substrate 1 under the condition of the temperature of 60° C. Thereafter, the support 4 was removed by peeling off. As such, by transferring the dry film from the support to the substrate, the first resin layer 6 (negative photosensitive resin layer) which is a portion (flow path wall) of the flow path forming member 21 is formed. Transfer was performed by a roll type laminator. The thickness of the first resin layer 6 after transfer was 15.0 μm, and the unevenness of the surface was 2.0 μm as measured by a white interferometer.

Next, as shown in FIG. 2D, the first resin layer 6 was exposed to light having a wavelength of 365 nm at an exposure amount of 1000 J/m² using an exposure apparatus, thereby forming the pattern 7 of the liquid flow path.

Next, as shown in FIG. 2E, the second resin layer 8 for forming a portion of the flow path forming member 21 (ejection orifice forming member) was formed. As the coating solution for forming the second resin layer 8, a solution obtained by dissolving an epoxy resin (manufactured by Mitsubishi Chemical Corporation, product name: 157S70) and a photoacid generator (manufactured by San-Apro Ltd., product name: LW-S1) in PGMEA was prepared.

The coating solution was coated on the first resin layer 6 by a spin coater, and dried by rotating at 300 rpm for 30 minutes (at room temperature), thereby forming the second resin layer 8 (negative photosensitive resin layer). The thickness of the second resin layer 8 was 5.0 μm, and the unevenness of the surface was 2.0 μm as measured by a white interferometer. The softening temperature of the second resin layer 8 was 40° C.

Next, as shown in FIG. 2F, the second resin layer 8 was exposed to light having a wavelength of 365 nm at an exposure amount of 10000 J/m² using an exposure apparatus, thereby forming the pattern 9 of the liquid ejection orifice.

Next, the second surface 24 of the substrate was brought into contact with a hot plate, and PEB was continuously performed at 50° C. for 5 minutes (step (5)) and at 90° C. for 5 minutes (step (6)). Since the thermal conductivity of the substrate is high, heating times (a heating time from room temperature to 50° C. and a heating time from 50° C. to 90° C.) were short enough to be ignored.

Here, after PEB at 50° C. for 5 minutes, the hardness of the portion which becomes the flow path forming member 21 of the second resin layer 8 (non-latent image portion) was measured to be 41.5 HV1. In addition, the hardness was Vickers hardness measured at test force of 9.8 N. In addition, after PEB at 90° C. for 5 minutes, the hardness of the non-latent image portion of the second resin layer 8 was measured to be 50.5 HV1, and the unevenness of the surface was 3.0 μm, as measured by a white interferometer. In all examples, in the non-latent portions (exposed portion) of the second resin layer 8, the hardness of the portion positioned on the non-latent image portion (exposed portion) of the first resin layer 6 was measured.

Next, as shown in FIG. 2G the pattern 7 of the liquid flow path and the pattern 9 of the liquid ejection orifice were developed by being immersed in PGMEA, thereby forming the liquid flow path 10 and the liquid ejection orifice 25 to obtain the flow path forming member 21.

Finally, the unevenness of the surface of the flow path forming member 21 of the finished liquid ejection head was 3.0 μm as measured by a white interferometer.

### Example 2

A liquid ejection head was manufactured in the same manner as in Example 1, except PEB conditions were changed, and various measurements were performed.

In PEB, the second surface 24 of the substrate was brought into contact with a hot plate, and PEB was continuously performed at 40° C. for 5 minutes, at 50° C. for 5 minutes, at 80° C. for 5 minutes, and 90° C. for 5 minutes. Here, after PEB at 50° C. for 5 minutes, the hardness of the non-latent image portion of the second resin layer 8 was measured to be 45.0 HV1. In addition, after PEB at 90° C. for 5 minutes, the hardness of the non-latent image portion of the second resin layer 8 was measured to be 50.5 HV1, and the unevenness of the surface was 2.5 μm as measured by a white interferometer.

The unevenness of the surface of the flow path forming member 21 of the finished liquid ejection head was 2.5 μm.

### Example 3

The substrate 1 was prepared in the same manner as in Example 1 (FIG. 4A). In addition, a coating solution for forming the dry film 5 in the same manner as in Example 1, the coating solution was coated on the dry film-formed surface of the support 4, and dried at 120° C. by an oven to form the dry film 5 (FIG. 4B). The softening temperature of the dry film 5 was 65° C.

Next, the dry film was transferred from a support to the substrate, in the same manner as in Example 1, except that the transfer temperature was 70° C. (FIG. 4C). The thickness of the first resin layer 6 after transfer was 15.0 μm, and the unevenness of the surface was 2.5 μm as measured by a white interferometer.

Next, the first resin layer 6 was exposed in the same manner as in Example 1 to form the pattern 7 of the liquid flow path (FIG. 4D).

Next, as shown in FIG. 4E, the dry film 12 supported by the support 11 was prepared. In the support 11, a PET film having a thickness of 100 μm was used, and the dry-film formed surface was subjected to release treatment. As a coating solution for forming the dry film 12, a solution obtained by dissolving an epoxy resin (manufactured by Mitsubishi Chemical Corporation, product name: 157S70) and a photoacid generator (manufactured by San-Apro Ltd., product name: LW-S1) in PGMEA was prepared. The coating solution was coated on the dry film-formed surface of the support 11, and dried at 70° C. by an oven, thereby forming the dry film 12. The softening temperature of the dry film 12 (thus the softening temperature of the second resin layer 8) was 38° C.

Next, as shown in FIG. 4F, the dry film 12 supported by the support 11 was adhered on the first resin layer 6 under the condition of the temperature of 55° C. Thereafter, the support 11 was removed by peeling off. As such, the dry film was transferred from the support to the substrate, thereby forming the second resin layer 8 (negative photosensitive resin layer) for forming a portion of a flow path forming member 21 (ejection orifice forming member). Transfer was performed by a roll type laminator. The thickness of the second resin layer 8 after transfer was 5.0 μm, and the unevenness of the surface was 1.0 μm as measured by a white interferometer.

Next, the second resin layer 8 was exposed in the same manner as in Example 1, thereby forming the pattern 9 of the liquid ejection orifice (FIG. 4G).

Next, PEB was performed in the same manner as in Example 1. Here, after PEB at 50° C. for 5 minutes, the hardness of the portion of the second resin layer 8 which would be the flow path forming member 21 (non-latent image portion) was measured to be 43.0 HV1. In addition, after PEB at 90° C. for 5 minutes, the hardness of the non-latent image portion of the second resin layer 8 was measured to be 50.5 HV1, and the unevenness of the surface was 2.0 μm as measured by a white interferometer.

Next, development was performed in the same manner as in Example 1 (FIG. 4H). Finally, the unevenness of the surface of the flow path forming member 21 of the finished liquid ejection head was 2.0 μm as measured by a white interferometer.

### Example 4

A liquid ejection head was manufactured in the same manner as in Example 3, except that PEB conditions were changed, and various measurements were performed.

In PEB, the substrate 1 with the first resin layer 6 and the second resin layer 8 formed thereon was heated from the side of the second resin layer 8 using a halogen lamp, thereby continuously performing PEB at 50° C. for 5 minutes and at 90° C. for 5 minutes. Here, after PEB at 50° C. for 5 minutes, the hardness of the non-latent image portion of the second resin layer 8 was measured to be 41.5 HV1. In addition, after PEB at 90° C. for 5 minutes, the hardness of the non-latent image portion of the second resin layer 8 was measured to be 50.5 HV1, and the unevenness of the surface was 1.5 μm as measured by a white interferometer.

The unevenness of the surface of the flow path forming member 21 of the finished liquid ejection head was 1.5 μm.

### Comparative Example 1

The substrate 1 was prepared in the same manner as in Example 1 (FIG. 2A). In addition, the dry film 5 was prepared in the same manner as in Example 1 (FIG. 2B). However, the softening temperature of the dry film 5 was 60° C.

Next, the dry film was transferred from the support to the substrate in the same manner as in Example 1, except that the transfer temperature was 65° C. (FIG. 2C). The thickness of the first resin layer 6 after transfer was 15.0 μm, and the unevenness of the surface was 2.3 μm as measured by a white interferometer.

Next, the first resin layer 6 was exposed in the same manner as in Example 1, thereby forming the pattern 7 of the liquid flow path (FIG. 2D). Next, the second resin layer 8 was formed in the same manner as in Example 1 (FIG. 2E). The thickness of the second resin layer 8 was 5.0 μm, and the unevenness of the surface was 4.0 μm as measured by a white interferometer.

Next, the second resin layer 8 was exposed in the same manner as in Example 1, thereby forming the pattern 9 of the liquid ejection orifice (FIG. 2F). Next, the second surface 24 of the substrate was brought into contact with a hot plate, and PEB was performed at 90° C. for 5 minutes. After PEB, the hardness of the non-latent image portion of the second resin layer 8 was measured to be 50.5 HV1, and the unevenness of the surface was 15.5 μm as measured by a white interferometer.

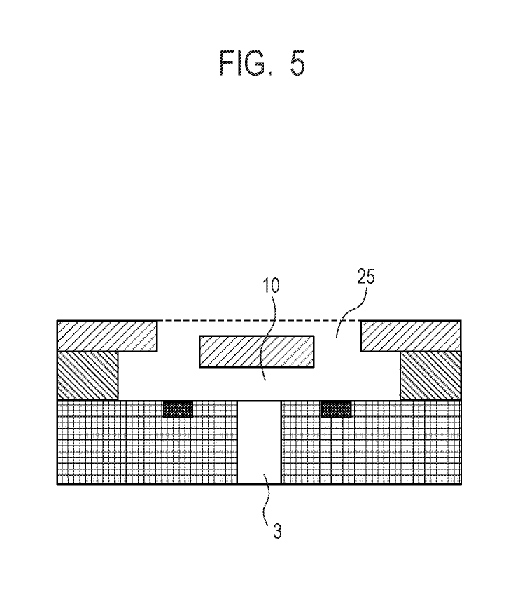

Next, development was performed in the same manner as in Example 1. Finally, the unevenness of the surface of the flow path forming member 21 of the finished liquid ejection head was 15.5 μm as measured by a white interferometer. Here, as schematically shown in FIG. 5, in the non-latent image portion of the second resin layer 8, the portion positioned on the liquid flow path pattern 7 (the latent image portion of the first resin layer 6) was depressed.

### Comparative Example 2

The liquid ejection head was manufactured in the same manner as in Comparative Example 1, except that PEB conditions were changed, and various measurements were performed.

In PEB, the second surface 24 of the substrate was brought into contact with a hot plate, and PEB was continuously performed at 70° C. for 5 minutes and 90° C. for 5 minutes. Here, after PEB at 70° C. for 5 minutes, the hardness of the non-latent image portion of the second resin layer 8 was measured to be 47.5 HV1. In addition, after PEB at 90° C. for 5 minutes, the hardness of the non-latent image portion of the second resin layer 8 was measured to be 50.5 HV1, and the unevenness of the surface was 12.5 μm as measured by a white interferometer.

The unevenness of the surface of the finished liquid ejection head was 12.5 μm as measured by a white interferometer. In this example also, like Comparative Example 1, in the non-latent image portion of the second resin layer 8, the portion positioned on the liquid flow path pattern 7 was depressed.

The conditions of each example and measurement results are summarized in Table 1.

TABLE 1

| | | | | | | | Comp. | Comp. |
|---|---|---|---|---|---|---|---|---|
| | | | Example 1 | Example 2 | Example 3 | Example 4 | Example 1 | Example 2 |
| First resin layer | Softening temperature | ° C. | 55 | 55 | 65 | 65 | 60 | 60 |
| (dry film transfer) | Transfer temperature | ° C. | 60 | 60 | 70 | 70 | 65 | 65 |
| | Thickness | μm | 15 | 15 | 15 | 15 | 15 | 15 |
| | Unevenness | μm | 2.0 | 2.0 | 2.5 | 2.5 | 2.3 | 2.3 |
| Second resin layer | Forming method | — | Spin | Spin | Dry film | Dry film | Spin | Spin |
| | | | coating | coating | transfer | transfer | coating | coating |
| | Softening temperature | ° C. | 40 | 40 | 38 | 38 | — | — |
| | Transfer temperature | ° C. | — | — | 55 | 55 | — | — |
| | Thickness | μm | 5.0 | 5.0 | 5.0 | 5.0 | 5.0 | 5.0 |
| | Unevenness | μm | 2.0 | 2.0 | 1.0 | 1.0 | 4.0 | 4.0 |
| PEB | Heating source | | Hot plate | Hot plate | Hot plate | Halogen | Hot plate | Hot plate |
| | | | | | | lamp | | |
| | 40° C., 5 min | | — | Present | — | — | — | — |
| | 50° C., 5 min | | Present | Present | Present | Present | — | — |
| | 70° C., 5 min | | — | — | — | — | — | Present |
| | 80° C., 5 min | | — | Present | — | — | — | — |
| | 90° C., 5 min | | Present | Present | Present | Present | Present | Present |
| Cure degree of first | | | | | | | — | |
| resin layer | | | | | | | | |
| | After PEB of STEP1 | HV1 | 41.5 | 45.0 | 43.0 | 41.5 | — | — |
| | temperature range | | | | | | | |
| | After PEB of STEP2 | HV1 | 50.5 | 50.5 | 50.5 | 50.5 | 50.5 | 50.5 |
| | temperature range | | | | | | | |
| Unevenness of flow | | μm | 3.0 | 2.5 | 2.0 | 1.5 | 15.5 | 12.5 |
| path forming member | | | | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-029886, filed Feb. 22, 2018, which is hereby incorporated by reference herein in its entirety.

What is claimed is:

1. A manufacturing method of a liquid ejection head including a substrate and a flow path forming member, the substrate being provided with a liquid ejection energy generating element on a first surface, the flow path forming member having a liquid ejection orifice and forming a liquid flow path between the flow path forming member and the first surface, the method comprising the following in an order listed:
(1) providing a negative first photosensitive resin layer on the first surface,
(2) forming a latent image of a pattern of the liquid flow path by exposure on the first photosensitive resin layer,
(3) providing a negative second photosensitive resin layer on the first photosensitive resin layer,
(4) forming a latent image of a pattern of the liquid ejection orifice by exposure on the second photosensitive resin layer,
(5) heating the first and second photosensitive resin layers at a temperature less than a softening temperature of the first photosensitive resin layer, so that a Vickers hardness of a non-latent image portion of the second photosensitive resin layer is 80% or more of a Vickers hardness of the non-latent image portion after (6), and
(6) heating the first and second photosensitive resin layers at a temperature more than or equal to the softening temperature of the first photosensitive resin layer.

2. The manufacturing method of a liquid ejection head according to claim 1, wherein in (5) and (6), the substrate provided with the first and second photosensitive resin layers is heated from a side of the second photosensitive resin layer.

3. The manufacturing method of a liquid ejection head according to claim 1, wherein the first photosensitive resin layer has the softening temperature of 50° C. or more.

4. The manufacturing method of a liquid ejection head according to claim 1, wherein in (3), a dry film supported by a support is transferred on the first photosensitive resin layer, thereby providing the second photosensitive resin layer.

5. The manufacturing method of a liquid ejection head according to claim 4, wherein the transfer is performed at a temperature less than the softening temperature of the first photosensitive resin layer.

6. The manufacturing method of a liquid ejection head according to claim 1, wherein a softening temperature of the second photosensitive resin layer is lower than the softening temperature of the first photosensitive resin layer by 10° C. or more.

7. The manufacturing method of a liquid ejection head according to claim 6, wherein the second photosensitive resin layer has the softening temperature of 40° C. or less.

8. The manufacturing method of a liquid ejection head according to claim 1, wherein before (5), the substrate has a hole opening to the first surface.

9. The manufacturing method of a liquid ejection head according to claim 1, wherein after (6), further comprising developing the latent image of the pattern of the liquid flow path and the latent image of the pattern of the liquid ejection orifice.
